(19) United States
(12) Patent Application Publication
(10) Pub. No.: US 2006/0146086 A1
(43) Pub. Date: Jul. 6, 2006

(54) Printhead temperature control method and apparatus

(75) Inventors: Hsiang-Pei Ou, Taichung City (TW); Hsiao-Yu Han, Taipei City (TW); Chieh-Yi Huang, Hsinchu County (TW)

Correspondence Address: BIRCH STEWART KOLASCH & BIRCH, PO BOX 747, FALLS CHURCH, VA, 22040-0747, US

(73) Assignee: INDUSTRIAL TECHNOLOGY RESEARCH INSTITUTE

(21) Appl. No.: 11/165,164

(22) Filed: Jun. 24, 2005

(30) Foreign Application Priority Data
Dec. 30, 2004 (TW) 93141352

(51) Int. Cl. B41J 29/38

(52) U.S. Cl. 347/17

(57) ABSTRACT

A temperature control apparatus for a printhead, disposed on a printer and controlled by a printhead driver. A printhead temperature detector detects and outputs a printhead temperature. A controller receives the temperature and searches a corresponding temperature-voltage table selected in accordance with a printhead mode signal to acquire a voltage value. A voltage regulator coupled to power and the controller outputs the corresponding voltage according to the voltage value to the printhead to adjust the temperature of the printhead.

### BACKGROUND

The invention relates to printhead temperature control and more particularly to a printhead temperature control method and apparatus.

Inkjet printers heat the printhead nozzles by increasing the voltage therefore. When the printer changes from non-print mode to print mode, printhead nozzles are heated to a predetermined temperature. This delays the printing.

FIG. 1 is a flowchart illustrating a printhead temperature control method as disclosed in U.S. Pat. No. 5,774,137. When the printhead driving voltage V is at first level V1 and the detected temperature exceeds second threshold T2, driving pulse voltage V is raised to the second level V2. The driving pulse voltage V is maintained at the second level V2 even though ambient temperature slightly changes. When the printhead temperature falls below the threshold T1, the driving pulse voltage V is switched to the first level V1. The driving pulse voltage V is maintained at first level V1 even though ambient temperature changes. Although the method illustrated in FIG. 1 maintains printhead temperature within a predetermined range, the continuous output of voltage consumes excessive power.

FIG. 2 is a waveform illustrating another printhead temperature control method. In area 21, the print system provides pre-heating voltage pulses in a specific frequency to maintain printhead temperature, but the power consumption is not well controlled. In area 22, the print system provides a pre-heating voltage pulse 23 only before the print signal. Although this print system reduces the power consumption, the pre-heating voltage pulses still can't heat the printhead to a predetermined temperature in time.

### SUMMARY

The invention provides a printhead temperature control method and apparatus thereof.

In embodiments of a printhead temperature control apparatus, the printhead, disposed on the printer, is controlled by a driver. The apparatus comprises several temperature-voltage tables, a printhead temperature detector, a controller and a voltage regulator. The printhead temperature detector is operable to detect and output a printhead temperature. The controller receives the temperature and searches a corresponding temperature-voltage table selected in accordance with a printhead mode signal, and acquires a voltage value. The voltage regulator, coupled to a power and the controller, outputs corresponding voltage to the printhead to adjust the temperature thereof.

The invention further provides a temperature control method for a printhead, wherein the printhead is disposed on the printer and controlled by a printhead driver, the method comprising providing several temperature-voltage tables, selecting a corresponding temperature-voltage table in accordance with the printhead mode, detecting the printhead temperature, searching the corresponding temperature-voltage table to acquire a voltage and outputting the voltage to the printhead.

### BRIEF DESCRIPTION OF THE DRAWINGS

FIG. 1 is a flowchart of a printhead temperature control method as disclosed in U.S. Pat. No. 5,774,137.

FIG. 2 is a waveform of another conventional printhead temperature control method.

FIG. 3 is a block diagram of an embodiment of a printhead temperature control apparatus in accordance with the invention.

FIG. 4 is a schematic diagram of printhead temperature to voltage.

FIG. 5 is a flowchart of a printhead temperature control method in print mode.

FIG. 6 is a flowchart of a printhead temperature control method in non-print mode.

FIG. 7 is a flowchart of a printhead temperature control method in clean mode.

FIG. 8 is a flowchart of a printhead temperature control method when printhead nozzles are blocked.

FIG. 9 is an exemplary circuit with adjustable output voltages in accordance with the embodiment of FIG. 3.

FIG. 10 is another exemplary circuit with adjustable output voltage in accordance with the embodiment of FIG. 3.

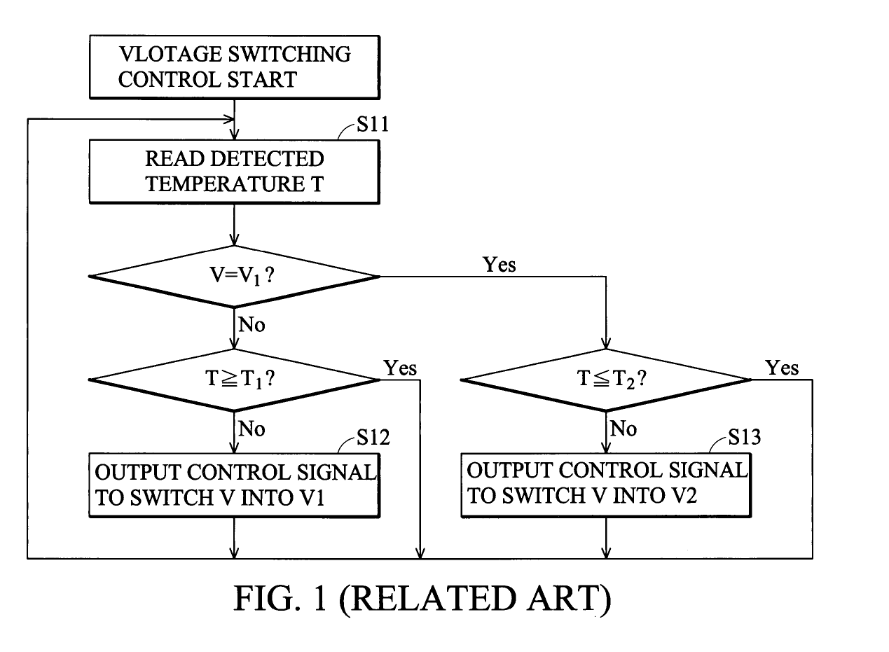

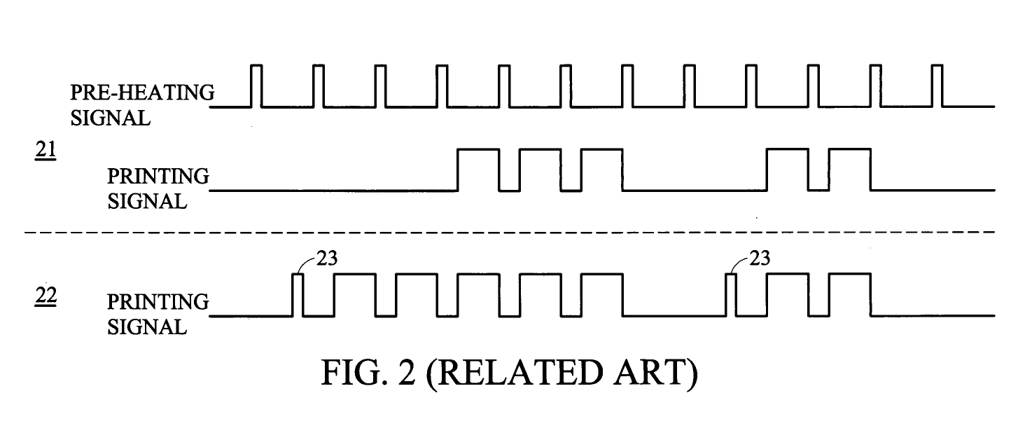

### DETAILED DESCRIPTION

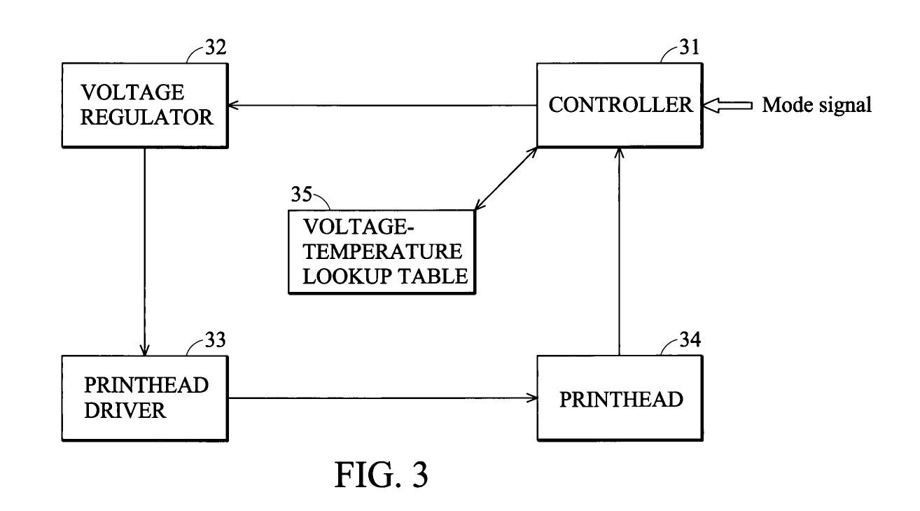

FIG. 3 is a block diagram of an embodiment of a printhead temperature control apparatus in accordance with the invention. The controller 31 receives a printhead mode signal and selects a corresponding temperature-voltage table from temperature-voltage table unit 35. Controller 31 detects the printhead temperature and searches the corresponding-temperature-voltage table to acquire a voltage value thereof. The voltage regulator 32 outputs the corresponding voltage to a printhead driver 33, driving printhead 34.

The temperature-voltage table unit 35 comprises several temperature-voltage tables, such as a print mode temperature-voltage table, a non-print mode temperature-voltage table and a clean mode temperature-voltage table. The controller selects the corresponding temperature-voltage table to optimize-power management.

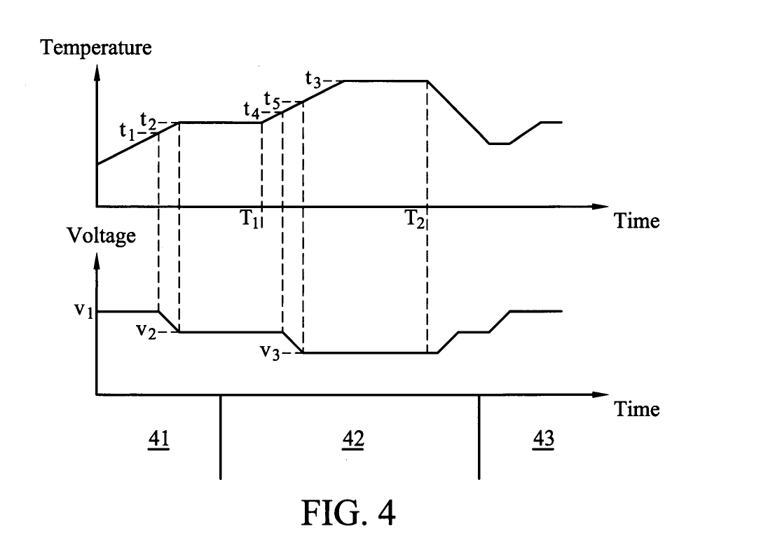

FIG. 4 is a schematic diagram of printhead temperature to voltage. In area 41, since the printhead temperature is lower than a pre-print temperature t2, voltage regulator 32 outputs a predetermined voltage V1 until the printhead temperature exceeds the temperature t1. When the printhead temperature is between temperatures t1 and t2, the voltage regulator 32 decreases the driving voltage and when the printhead temperature equals pre-print temperature t2, outputs voltage V2. In area 42, the voltage regulator 32 outputs the voltage V2 to maintain temperature in temperature t2 before time T1. Since the heat generated exceeds that radiated, printhead temperature increases. When the printhead temperature exceeds temperature t4, the voltage regulator 32 decreases the driving voltage. When printhead temperature equals temperature t5, the voltage regulator 32 outputs a voltage V3 but printhead temperature continues to increase to print temperature t3. At time T2, as ink is output, the printhead temperature decreases rapidly. As the controller 31 detects the printhead output, the voltage regulator 32 increases the driving voltage to voltage V2. In area 43, the detected printhead temperature is lower than temperature t1 and the voltage regulator 32 outputs the voltage V1 to heat the printhead to a pre-print temperature t2.

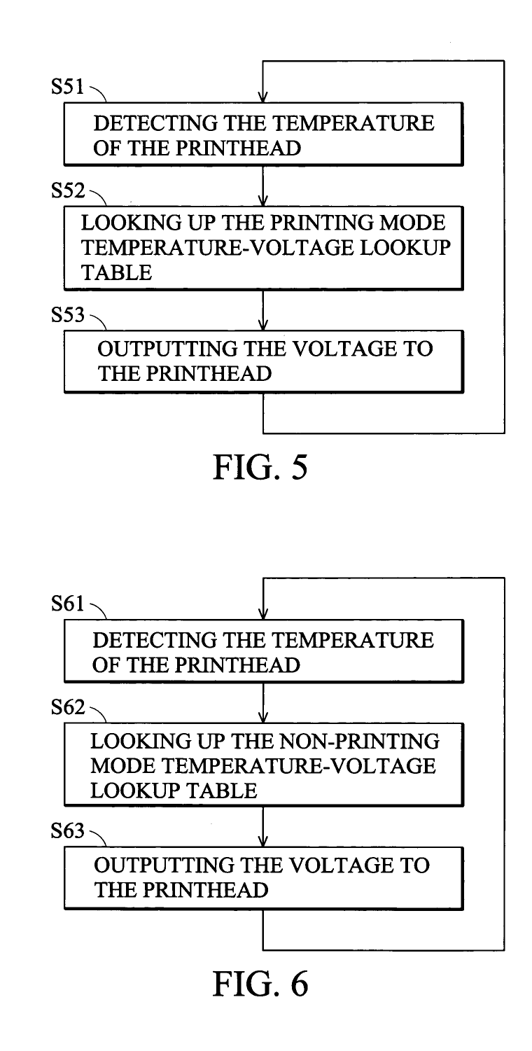

FIG. 5 is a flowchart of a printhead temperature control method in a print mode. In step S51, the controller detects the printhead temperature. In step S52, the controller searches the print mode temperature-voltage table in accordance with the detected temperature to acquire a voltage value and transmits to the voltage regulator 32. In step S53, the voltage regulator 32 outputs the corresponding voltage to the printhead driver 33 to drive the printhead 34. Repeating steps S51 to S53, maintains a predetermined temperature, such as print temperature t3 in FIG. 4.

FIG. 6 is a flowchart of a printhead temperature control method in non-print mode. In step S61, the controller detects the printhead temperature. In step S62, the controller searches the non-print mode temperature-voltage table in accordance with the detected temperature to acquire a voltage value and transmits to the voltage regulator 32. In step S63, the voltage regulator 32 outputs the corresponding voltage to the printhead driver 33 to drive the printhead 34. Repeating steps S61 to S63, maintains a predetermined temperature, such as pre-print temperature t2 in FIG. 4, decreasing time between pre-print temperature and print temperature.

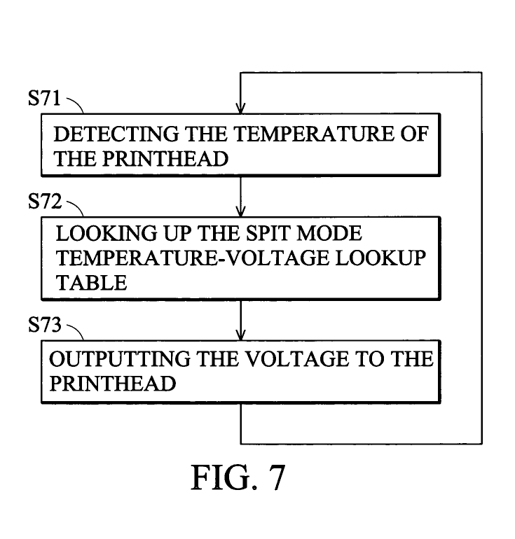

FIG. 7 is a flowchart of a printhead temperature control method in clean mode. In step S71, the controller detects the printhead temperature. In step S72, the controller searches the clean mode temperature-voltage table in accordance with the detected temperature to acquire a voltage value and transmits to the voltage regulator 32. In step S63, the voltage regulator 32 outputs the corresponding voltage to the printhead driver 33 to drive the printhead 34. When the printhead 34 is in clean mode, it not only cleans the nozzles but raises the temperature, decreasing heating time.

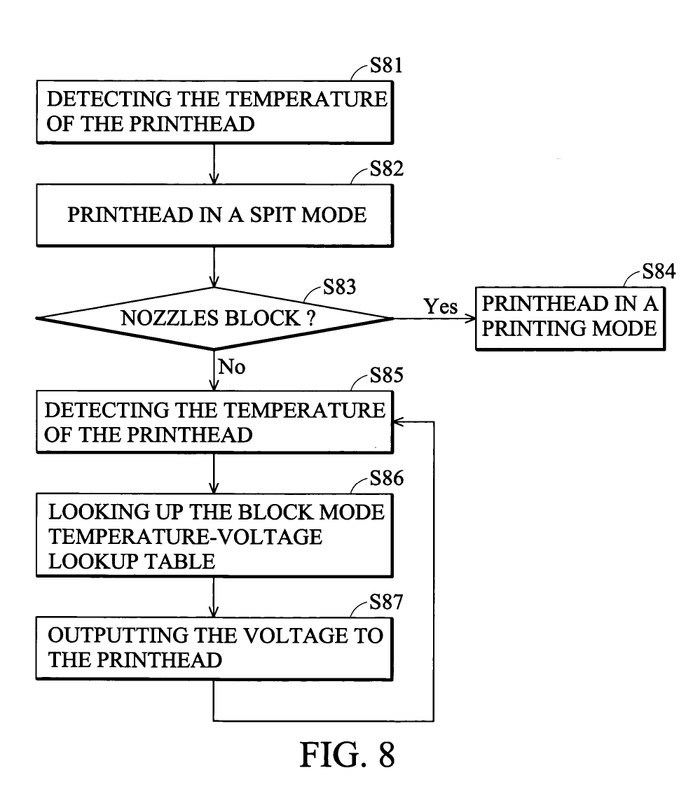

When in the clean mode, the printhead receives a higher voltage so that the printhead nozzles may be damaged if blocked. FIG. 8 is a flowchart of a printhead temperature control method when printhead nozzles are blocked. In step S81, the controller 31 detects the printhead temperature and sets printhead 34 in clean mode. The controller. 31 determines if the printhead nozzles are block (step S83). If not, the printhead 34 enters print mode (step S84). If printhead nozzles are blocked, controller 31 detects the printhead temperature (step S85) and searches the blocked temperature-voltage table to acquire a voltage value in accordance with the detected temperature (step S86). The voltage regulator 32 outputs the corresponding voltage to the printhead driver 33 to drive the printhead 34. Repeating steps S85 to S87 avoids damage to the printhead nozzles.

According to the embodiment illustrated in FIG. 3, the voltage regulator 32 is a circuit with adjustable output voltages. The voltage regulator 32 outputs the driving voltage to the printhead driver 33 and the printhead driver 33 transmits it to the printhead 34 by primitive lines. The present disclosure illustrates the voltage regulator with specific circuits.

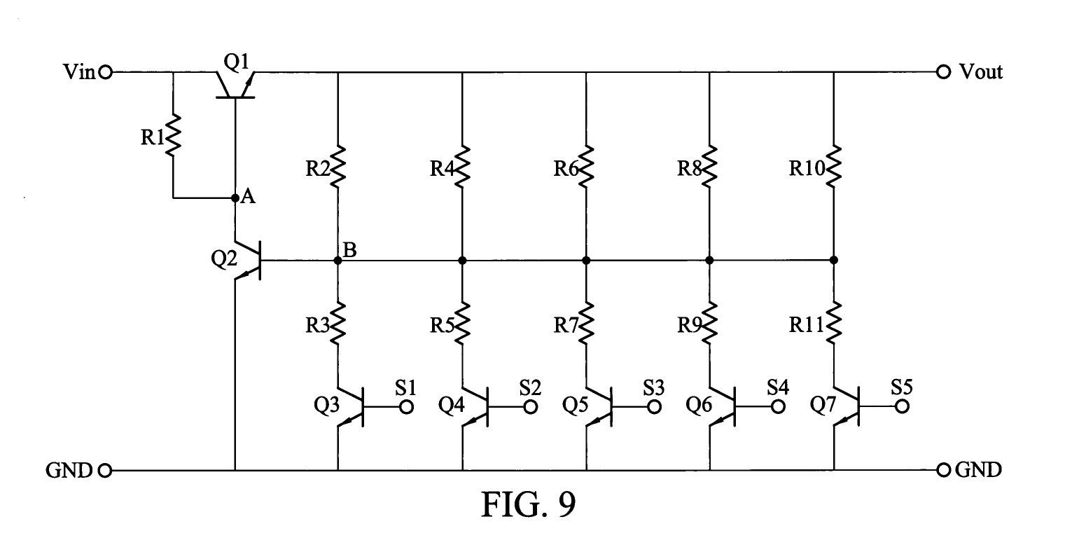

FIG. 9 is an exemplary circuit with adjustable output voltages in accordance with the embodiment of FIG. 3. The input voltage Vin is coupled to the power of a printer and the voltage Vout is the output of the voltage regulator 32. The voltage Vout depends on the conductivity of transistor Q1, the conductivity of transistor Q1 depends on the voltage of node A, and the voltage of node A depends on the voltage of node B. With R2, R3 and transistor Q3 as examples, when the select signal S1 is at a high voltage level, the transistor Q3 turns on, and the voltage of node B is generated by the dividing voltage of the output voltage Vout. The voltage of node B determines the conductivity of transistor Q2 and the conductivity of transistor Q2 determines the voltage of node A thereof. The voltage of node A determines the conductivity of transistor Q1, and the conductivity of transistor Q1 determines the output voltage Vout thereof. According to feedback control, output voltage Vout is adjusted in accordance with R2 and R3. If output voltage Vout is determined by (R2, R3, Q3), the controller outputs select signals S1˜S5 [1, 0, 0, 0, 0]. If the output voltage Vout is determined by (R8, R9, Q6) and (R10, R11, Q7), the controller outputs the select signals S1˜S5 [0, 0, 0, 1, 1]. The advantage of the exemplary circuit is simple and easily adjusts the output voltage Vout in accordance with (R2, R3), (R4, R5), (R6, R7), (R8, R9), (R10, R11).

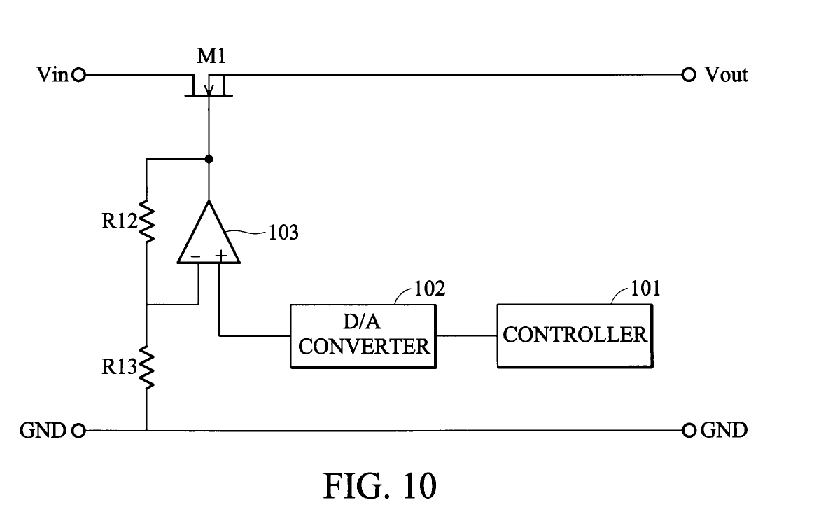

FIG. 10 shows another exemplary circuit with adjustable output voltages in accordance with the embodiment of FIG. 3. The input voltage Vin is coupled to the power of a printer and the voltage Vout is the output of the voltage regulator 32. The controller 31 detects the printhead temperature and searches the corresponding temperature-voltage table to acquire a voltage value therefore. The controller 101 receives the voltage value and transmits it to the DAC (Digital Analogue Converter) 102. The DAC 102 outputs a corresponding voltage to an OPA (Operation Amplifier) 103. The OPA 103 is coupled to a gate of a transistor M1 and the conductivity of transistor M1 depends on the output voltage of the OPA 103 so that we can adjust the output voltage Vout.

While the invention has been described by way of example and in terms of preferred embodiment, it is to be understood that the invention is not limited thereto. To the contrary, it is intended to cover various modifications and (as would be apparent to those skilled in the art). Therefore, the scope of the appended claims should be accorded the broadest interpretation so as to encompass all such modifications.

What is claimed is:

1. A printhead temperature control apparatus, wherein a printhead is disposed on a printer and controlled by a printhead driver, the apparatus comprising:
a plurality of temperature-voltage tables;
a printhead temperature detector operable to detect a printhead temperature and output it;
a controller operable to receive the temperature and search a corresponding temperature-voltage table selected in accordance with a printhead mode signal to acquire a corresponding voltage value; and
a voltage regulator coupled to power and the controller, operable to output the voltage according to the voltage value to the printhead, adjusting the printhead temperature.

2. The apparatus of claim 1, wherein the temperature-voltage tables comprise a print mode temperature-voltage table; and when the printhead is in a print mode, the controller selects the print mode temperature-voltage table to acquire a voltage value and the voltage regulator outputs the corresponding voltage to the printhead to maintain a predetermined print temperature.

3. The apparatus of claim 1, wherein the temperature-voltage tables comprise a non-print mode temperature-voltage table; and when the printhead is in a non-print mode, the controller selects the non-print mode temperature-voltage table to acquire a voltage value and the voltage regulator outputs the corresponding voltage to the printhead to achieve a predetermined pre-print temperature.

4. The apparatus of claim 1, wherein the temperature-voltage tables comprise a clean mode temperature-voltage table; and when the printhead is in a clean mode, the controller selects the clean mode temperature-voltage table to acquire a voltage value and the voltage regulator outputs the corresponding voltage to clean the printhead nozzles.

5. The apparatus of claim 4, wherein when the printhead temperature exceeds an upper limit, the voltage regulator decreases output voltage.

6. The apparatus of claim 1, wherein the voltage regulator outputs the voltage to the printhead by the printhead driver.

7. The apparatus of claim 6, wherein the printhead driver transmits the voltage to the printhead by primitive select lines.

8. A temperature control method for a printhead, wherein the printhead is disposed on a printer and controlled by a printhead driver, comprising:
(a) providing a plurality of temperature-voltage tables;
(b) selecting a corresponding temperature-voltage table in accordance with the printhead mode;
(c) detecting the printhead temperature;
(d) searching the corresponding temperature-voltage table to acquire a voltage value; and
(e) outputting the corresponding voltage to the printhead.

9. The method of claim 8, wherein the temperature-voltage tables comprise a print mode temperature-voltage table; and when the printhead is in a print mode, repeating steps (c) to step (e) to maintain a predetermined print temperature.

10. The method of claim 8, wherein the temperature-voltage tables comprise a non-print mode temperature-voltage table; and when the printhead is in a non-print mode, repeating steps (c) to step (e) to reach a predetermined pre-print temperature.

11. The method of claim 8, wherein the temperature-voltage tables comprise a clean mode temperature-voltage table; when the printhead is in a clean mode, repeating steps (c) to step (e) to clean the printhead nozzles.

12. The method of claim 11, wherein when the printhead temperature exceeds an upper limit, the voltage regulator decreases output voltage.
